(19) United States
(12) Patent Application Publication
(10) Pub. No.: US 2007/0282460 A1
(43) Pub. Date: Dec. 6, 2007

(54) Control System for a Motor Vehicle

(75) Inventors: Markus Baumann, Stuttgart (DE); Volker Hellwig, Stuttgart (DE); Carla Knoop, Stuttgart (DE); Armin Zachay, Rechberghausen (DE)

Correspondence Address: CROWELL & MORING LLP;INTELLECTUAL PROPERTY GROUP, P.O. BOX 14300, WASHINGTON, DC, 20044-4300, US

(73) Assignee: Daimler Chrysler, Stuttgart (DE)

(21) Appl. No.: 10/584,456

(22) PCT Filed: Dec. 7, 2004
(86) PCT No.: PCT/EP04/13888

§ 371 Date: May 29, 2007

(30) Foreign Application Priority Data
Dec. 23, 2003 (DE) 103 60 658.0

(51) Int. Cl. G05B 15/02

(52) U.S. Cl. 700/10

(57) ABSTRACT

A control system for a motor vehicle has a manual actuator with degrees of freedom for selecting and/or activating entries in a menu structure with menu levels and a screen display having display areas for displaying the menu structure. Each of the display areas has at least field one for displaying one of the entries. In an active display area in at least one level of the menu structure, at least two entries are assigned to a settable parameter for setting with the manual actuator. A first entry is an analog display of the settable parameter, and a second entry is a digital display of the settable parameter.

This application is a National Phase of PCT/EP2004/013888, filed Dec. 7, 2004, and claims the priority of DE 103 60 658.0, filed Dec. 23, 2003, the disclosure of which is expressly incorporated by reference herein.

### BACKGROUND AND SUMMARY OF THE INVENTION

The present invention relates to a control system for a motor vehicle.

In modern vehicles, multimedia control systems are being increasingly used. An example of this is the command system in the Mercedes Benz S-class.

DE 197 52 056 A1 describes a control system for a motor vehicle in which two display areas are displayed on a screen display in a menu structure with a plurality of menu levels. A first display area is arranged as a frame around the second display area. In a first menu level, eight fields with entries which correspond to applications which can be carried out and which are arranged vertically and horizontally are displayed in the first display area. An entry is selected by a pushing or tilting movement of the manual actuator with a plurality of degrees of freedom of adjustment in the direction of the position of the corresponding entry in the first display area.

A selected entry in this known system is activated by pressing the manual actuator. After the activation, a plurality of vertically arranged entries which are assigned to the activated entry in the first menu level are displayed in a second menu level in the second display area. The entries displayed in the second display area are selected by rotational movement of the manual actuator and activated by pressing the manual actuator. The activated second display area and the second menu level are exited by the pushing or tilting movement of the manual actuator in the direction of a position of one of the entries in the first display area. The control system is then located in the first menu level in the first display area again.

An object of the invention is to provide an improved control system for a motor vehicle that permits intuitive control and reduces the scope of distracting information.

This object has been achieved by making available a control system in which an active display area in at least on level of the menu structure at least two entries are assigned to a settable parameter for setting with the manual actuator, a first entry being an analog display of the settable parameter, and a second entry being a digital display of the settable parameter.

As a result, the user can now consider, in accordance with his or her preference when setting a parameter, either the associated digital or analog display on a screen display without having to make further settings.

In order to set the at least one parameter, four degrees of freedom of adjustment of the manual actuator can be used. The value of the parameter can be increased by way a first degree of freedom of adjustment which corresponds, for example, to pushing the manual actuator in the positive y direction, or by a third degree of freedom of adjustment which corresponds, for example, to rotating the manual actuator in the clockwise direction about a z axis. The value of the parameter can be decreased by a second degree of freedom of adjustment which corresponds, for example, to pushing the manual actuator in the negative y direction or by a fourth degree of freedom of adjustment which corresponds, for example, to rotating the manual actuator in the counter-clockwise direction about a z axis.

The setting which is performed for the at least one parameter can be stored, for example, by operating the actuator with a fifth degree of freedom of adjustment, as a result of which in addition the active display area can be exited and closed. The fifth degree of freedom of adjustment corresponds, for example, to pushing the manual actuator in the negative z direction.

In one embodiment, at least one of the degrees of freedom of adjustment corresponds to the orientation of the parameter which is displayed in one of the entries.

In addition, the settable parameter can comprise a plurality of settable subparameters, one of which can be selected in each case by actuating the manual actuator with a sixth or seventh degree of freedom of adjustment. The sixth degree of freedom of adjustment corresponds, for example, to pushing the manual actuator in the positive x direction, and the seventh degree of freedom of adjustment corresponds, for example, to pushing the manual actuator in the negative x direction.

The subparameter which is selected for the purpose of setting can be visually highlighted by a changed graphic display.

In another contemplated embodiment, the at least one parameter represents a time, a first subparameter representing, for example, the hours, a second subparameter representing the minutes and a third subparameter representing the seconds.

Other objects, advantages and novel features of the present invention will become apparent from the following detailed description of the invention when considered in conjunction with the accompanying drawings.

### BRIEF DESCRIPTION OF THE DRAWINGS

FIG. 1 is a block circuit diagram of a control system for a motor vehicle;

FIG. 2 is a schematic illustration of a screen display from FIG. 1 in a first menu level; and

FIG. 3 is a schematic illustration of a display region of the screen display from FIG. 1 in a further menu level.

### DETAILED DESCRIPTION OF THE DRAWINGS

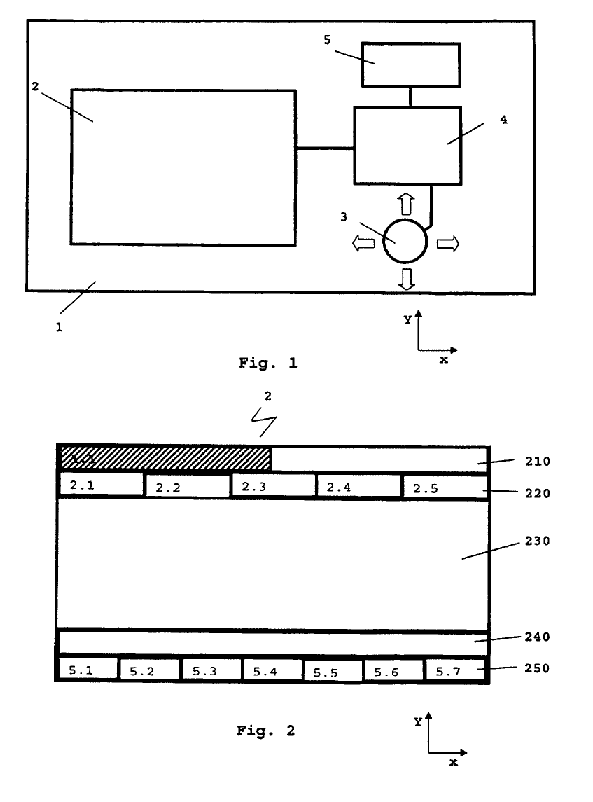

As is apparent from FIG. 1, the control system 1 for a motor vehicle comprises a screen display 2, a manual actuator 3, a control and evaluation unit 4, and a plurality of vehicle systems such as a navigation system, a heating system and an air conditioning system, a cellular telephone, a video system, an audio system, etc., which, for sake of simplicity and clarity, are illustrated, combined as one element 5. The vehicle systems transmit signals to the evaluation and control unit 4 from which the control and evaluation unit 4 determines current system states.

All the applications and/or functions and/or subfunctions and/or options and/or status displays in various menu levels of a menu structure are controlled by the manual actuator 3. The latter has seven degrees of freedom of adjustment for selecting and/or activating entries displayed in an active display area. The actuator 3 can be pushed in four directions according to the arrow illustration in FIG. 1, i.e., in a positive x direction, a negative x direction, in a positive y direction or in a negative y direction. In addition, it can be rotated in the clockwise direction or in the counter-clockwise direction about a z axis (not illustrated) which is perpendicular to the plane of the drawing, and can be pressed in the direction of the negative z direction, i.e., into the plane of the drawing.

Rotating the manual actuator 3 in the clockwise direction causes a cursor on the screen 2 to move to the right or downward as a function of a horizontal or vertical orientation of the entries displayed on the screen display 2, and turning it in the counter-clockwise direction causes the cursor to move to the left or upward. Pushing the manual actuator 3 in FIG. 1 upward, i.e., forward in the direction of the windshield, i.e., in the positive y direction, causes the cursor on the screen display 2 to move upward, and the pushing process in the downward direction in FIG. 1, i.e., toward the rear in the negative y direction, causes the cursor on the screen display 2 to move downward. Pushing to the right, i.e., in the positive x direction, causes the cursor on the screen display 2 to move to the right, and pushing to the left, i.e., in the negative x direction, causes the cursor to move to the left.

The selection and/or activation of an entry displayed on the screen display 2 are carried out by pushing or turning the manual actuator 3. In a way which is redundant with respect to the vertical pushing along an axis, i.e., with respect to the pushing in the y direction or with respect to the horizontal pushing along an axis, i.e., with respect to the pushing in the x direction, the manual actuator 3 can be rotated about the z axis. The pushing direction in order to select an entry corresponds here for example to the orientation of the entries displayed in the active display area. The pushing direction which is respectively orthogonal with respect to the selection pushing direction causes the active display area to be exited. In addition, in order to activate a selected entry it may be necessary to press the manual actuator 3.

As is clear from FIG. 2, the screen display 2 comprises, in a first menu level, a graphic basic structure of five vertically arranged, horizontal display areas 210 to 250. This graphic basis structure is constant over the multiplicity of various menu levels of the menu structure. The screen display 2 is configured, for example, as an eight inch screen with a ratio of the sides of 15:9. The graphic basic structure of at least a first of the display areas 210 to 250 of the screen display 2 is constant over the multiplicity of various menu levels of the menu structure. In FIG. 2, the display areas 210, 220, 240 and 250 are configured as such first display areas.

The graphic basis structure of at least a second of the display areas 210 to 250 is variable over the multiplicity of various menu levels of the menu structure as a function of an activated application and/or function and/or subfunction and/or option and/or status display. In FIG. 2, the display area 230 is configured as such as second display area. This central display area 230 may be configured graphically in very different ways.

One or more horizontally arranged entries 1.1 to 5.7 may be respectively displayed in the four display areas 210, 220, 240 and 250 which are configured as first display areas. For example, the display areas 210, 220, 240 and 250 in FIG. 2 in the first menu level each comprise a different number of entries. For example, the first display area 210 comprises one entry 1.1, the second display area 220 comprises five entries 2.1 to 2.5, the fourth display area comprises no entry and the fifth display area comprises seven entries 5.1 to 5.7. In FIG. 2, the first display area 210 is activated and the hatched entry 1.1. is selected. The hatched display is intended to indicate that the cursor is positioned on the entry 1.1.

The entries 1.1 to 5.7 of the display areas 210 to 250 displayed on the screen display 2 can be arranged according to the importance of their contents or their frequency of application. When the entries 1.1 to 5.7 are arranged vertically, the width of the individual fields for displaying said entries is dependent, for example, on the length of the longest entry. The field width may be additionally or alternatively dependent on the number of fields in a display area.

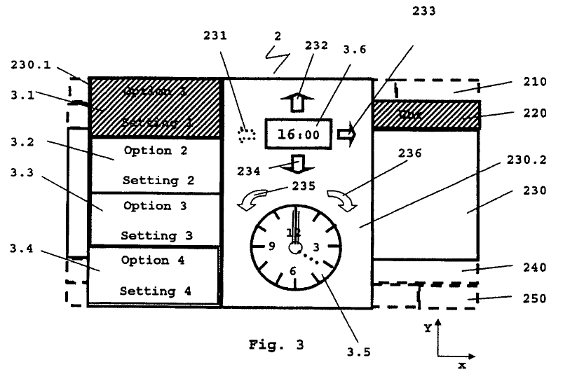

FIG. 3 shows the screen display 2 in a further menu level after an application time has been selected and activated in the second display area 220, and an option 1 from a submenu list 230.1 has been selected and activated in the display area 230. A further display area 230.2 is activated in order to set the parameter assigned to the option 1. In the illustrated exemplary embodiment, the submenu list 230.1 comprises four entries 3.1 to 3.4 which each comprise an option and a setting assigned to the respective option. The first entry 3.1 comprises the option 1 and the setting 1, the second entry comprises the option 2 and the setting 2 etc. The first entry serves, for example, for setting the time, and the setting 1 shows the current time. The second entry 3.2 serves, for example, for setting a starting time for a stationary-mode heater, and the setting 2 shows the instantaneously set starting time for the stationary-mode heater. The third entry 3.3 serves for example, for setting a stop time for the stationary-mode heater, and the setting 3 shows the instantaneously set stop time for the stationary-mode heater. The fourth entry 3.4 serves, for example, for setting a time for a memory function, and the setting 4 shows the instantaneously set time for the memory function.

In order to set the entries 3.1 to 3.4, the display area 230.2 is activated and opened after one of the entries 3.1 to 3.4 has been activated.

In FIG. 3, the entry 3.1 has been selected and activated by correspondingly actuating the manual actuator 3. As a result, the display area 230.2 is activated and opened. The display area 230.2 comprises two entries, a first entry 3.6 of which is configured as a digital display of the settable parameter, and a second entry 3.7 of which is configured as a digital display of the settable parameter. Before the parameter is set with the manual actuator 3, the currently stored value of the settable parameter is displayed, that value also being displayed in the corresponding entry 3.1 to 3.4 of the submenu list 230.1.

For the purpose of better orientation it is contemplated to display the possible degrees of freedom of adjustment of the manual actuator 3 by corresponding arrows 231 to 236. The arrow 232 shows a possible actuation with a first degree of freedom of adjustment in the positive y direction, thereby permitting the value of the settable parameter to be increased. The arrow 234 shows a possible actuation with a second degree of freedom of adjustment in the negative y direction, thereby permitting the value of the settable parameter to be decreased. The arrow 236 shows a possible actuation with a third degree of freedom of adjustment corresponding to a rotation of the manual actuator 3 about the z axis in the clockwise direction, thereby permitting the value of the adjustable parameter to be increased. The arrow 235 shows a possible actuation with a fourth degree of freedom of adjustment which corresponds to a rotation of the manual actuator 3 about the z axis in the counter-clockwise direction, thereby permitting the value of the settable parameter to be decreased.

The arrow 232 shows a possible actuation with a sixth degree of freedom of adjustment in the positive x direction. By way of this actuation, a currently settable subparameter, here the hours, can be changed to another subparameter, here the minutes. Actuation in the direction of the arrow 231 which is represented by dashed lines is not possible at this time since no further subparameter is arranged in this direction from the currently settable subparameter. Correspondingly, movement of the manual actuator 3 in this direction can be blocked. The arrow 231 may, for example, be completely removed from the display or displayed with a weaker intensity or a weaker contrast. Usually there is a display of when the minute subparameter is activated by corresponding actuation of the manual actuator 3. If the minutes subparameter is activated, the arrow 233 is displayed with a weaker intensity or a weaker contrast or completely removed from the display, in which case the actuation of the manual actuator 3 in the negative x direction can then also be blocked.

In the analog entry 3.5, the minute indicator is displayed by dashes and the hour indicator which can be set at this time is displayed in a highlighted fashion, i.e., the minute indicator can be displayed with a weaker intensity or a weaker contrast or removed from the display completely. When there is a changeover to the minute subparameter, the hour indicator is displayed with a weaker intensity or a weaker contrast or removed from the display completely.

The exiting of the active display area 230.2 is brought about by pressing the manual actuator 3. After a parameter setting has been performed, the currently set parameter value is stored and the activated display area 230.2 exited by pressing the manual actuator 3. The setting in the associated entry 3.1 to 3.4 now displays the newly set and stored value.

The inventive simultaneous displaying of an analog and a digital representation of a settable parameter enables the user to view the display which corresponds to his or her preference when setting the parameter.

As a result of the control system according to the invention, the control processes are simplified for the user and the cognitive load is reduced so that the user can concentrate better on events occurring on the road.

1-10. (canceled)

11. A control system for a motor vehicle, comprising a manual actuator with a plurality of degrees of freedom of adjustment for at least one of selecting and activating entries in a menu structure with a plurality of menu levels, and a screen display having a plurality of display areas for displaying the menu structure, each of the display areas comprising at least one field for displaying one of the entries, wherein, in an active display area in at least one level of the menu structure, at least two entries are assigned to a settable parameter for setting with the manual actuator, a first entry being an analog display of the settable parameter, and second entry being a digital display of the settable parameter.

12. The control system as claimed in claim 11, wherein the at least one parameter can be set by adjustment movement with at least one of a first, second, third or fourth of the plurality of degrees of freedom of adjustment of the manual actuator.

13. The control system as claimed in claim 12, wherein the setting performed by operating the actuator with a fifth degree of freedom of adjustment is stored, and the active display area is exited and closed.

14. The control system as claimed in claim 12, wherein at least one of the degrees of freedom of adjustment of the manual actuator corresponds to orientation of the parameter which is displayed in one of the entries.

15. The control system as claimed in claim 14, wherein the setting performed by operating the actuator with a fifth degree of freedom of adjustment is stored, and the active display area is exited and closed.
wherein the setting performed by operating the actuator with a fifth degree of freedom of adjustment is stored, and the active display area is exited and closed.

16. The control system as claimed in claim 12, wherein the settable parameter comprises a plurality of settable subparameters, one of which can be selected in each case by actuating the manual actuator with a sixth or seventh degree of freedom of adjustment.

17. The control system as claimed in claim 16, wherein the setting performed by operating the actuator with a fifth degree of freedom of adjustment is stored, and the active display area is exited and closed.

18. The control system as claimed in claim 17, wherein at least one of the degrees of freedom of adjustment of the manual actuator corresponds to orientation of the parameter which is displayed in one of the entries.

19. The control system as claimed in claim 16, wherein the subparameter which is selected for the purpose of setting is visually highlighted by a changed graphic display.

20. The control system as claimed in claim 11, wherein the at least one parameter represents a time.

21. The control system as claimed in claim 20, wherein a first subparameter represents hours, a second subparameter represents minutes and a third subparameter represents seconds.

22. The control system as claimed in claim 12, wherein, in an x-y-z coordinate system, the first degree of freedom of adjustment is pushing of the manual actuator in a positive y direction, the second degree of freedom of adjustment is pushing of the manual actuator in a negative y direction, the third degree of freedom of adjustment is rotation of the manual actuator in a clockwise direction about a z axis, the fourth degree of freedom of adjustment is rotation of the manual actuator in a counter-clockwise direction about a z axis, and a fifth degree of freedom of adjustment is pressing of the manual actuator in a negative z direction.

23. The control system as claimed in claim 12, wherein, in an x-y-z coordinate system, a sixth degree of freedom of adjustment is pushing of the manual actuator in a positive x direction, and a seventh degree of freedom of adjustment is pushing of the manual actuator in a negative x direction.
